(19) United States
(12) Patent Application Publication
(10) Pub. No.: US 2011/0225248 A1
(43) Pub. Date: Sep. 15, 2011

(54) MULTIMODAL CONVERSATION STATE AND TRANSFER THROUGH CENTRALIZED NOTIFICATION

(75) Inventors: Marc Boyer, Seattle, WA (US); Danny Levin, Bellevue, WA (US); Arulkumar Elumalai, Lynnwood, WA (US); Vinit Deshpande, Woodinville, WA (US)

(73) Assignee: Microsoft Corporation, Redmond, WA (US)

(21) Appl. No.: 12/723,900

(22) Filed: Mar. 15, 2010

(51) Int. Cl. G06F 15/16

(52) U.S. Cl. 709/206

(57) ABSTRACT

A mechanism is provided for enabling subscribers of an enhanced communication system to switch endpoints during a conversation, add or remove modalities, invite new participants while continuing the conversation seamlessly. Active endpoints associated with a participant in a conversation may publish their states to a managing server and become aware of a status of the ongoing conversation. Subsequently, the participants may seamlessly switch to another endpoint and continue the conversation using the other endpoint.

### BACKGROUND

Modern communication systems have a large number of capabilities including integration of various communication modalities with different services. For example, instant messaging, voice/video communications, data/application sharing, white-boarding, and other forms of communication may be combined with presence and availability information of subscribers. Such systems may provide subscribers with the enhanced capabilities such as providing instructions to callers for various status categories, alternate contacts, calendar information, and comparable features.

With the advent of modern communication systems such as unified communications and the prevalent use of desktop and soft-phone based telephony, the above mentioned modalities and others are commonly utilized in two-party or multi-party communications. While these modalities provide an enriched experience to the users, they also provide different challenges and opportunities for handling communications at the system level such as managing multiple endpoints for a subscriber.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a mechanism for enabling subscribers of an enhanced communication system to switch endpoints during a conversation, add or remove modalities, invite new participants while continuing the conversation seamlessly. According to some embodiments, active endpoints associated with a participant in a conversation publish their states to a managing server making the other endpoints of the participant aware of a status of the ongoing conversation. Subsequently, the participants may switch to another endpoint and continue the conversation using the other endpoint, or control the conversation from a different endpoint.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a diagram illustrating an example unified communications system, where embodiments may be implemented for managing multimodal conversations through centralized notification;

FIG. 2 is a diagram illustrating an example conversation between subscribers of an enhanced communication system with access to multiple endpoints;

FIG. 3 is a diagram illustrating the example conversation of FIG. 2, where one of the subscribers changes their endpoint continuing the conversation;

FIG. 4 is a diagram illustrating the example conversation of FIG. 3, where one of the subscribers invites a new participant to the conversation and the modalities of the conversation changes;

FIG. 5 is an action diagram illustrating interactions between the components of an enhanced communication system according to embodiments;

FIG. 6 is a networked environment, where a system according to embodiments may be implemented;

FIG. 7 is a block diagram of an example computing operating environment, where embodiments may be implemented; and

FIG. 8 illustrates a logic flow diagram for a process of managing multimodal conversations through centralized notification according to embodiments.

### DETAILED DESCRIPTION

As briefly described above, multimodal conversations in an enhanced communication system may be managed through centralized notification such that participants can switch endpoints, change modalities, and invite new participants while the conversation is occurring. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for managing multimodal communication systems. Examples of platforms include, but are not limited to, a hosted service executed over a plurality of servers, an application executed on a single server, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

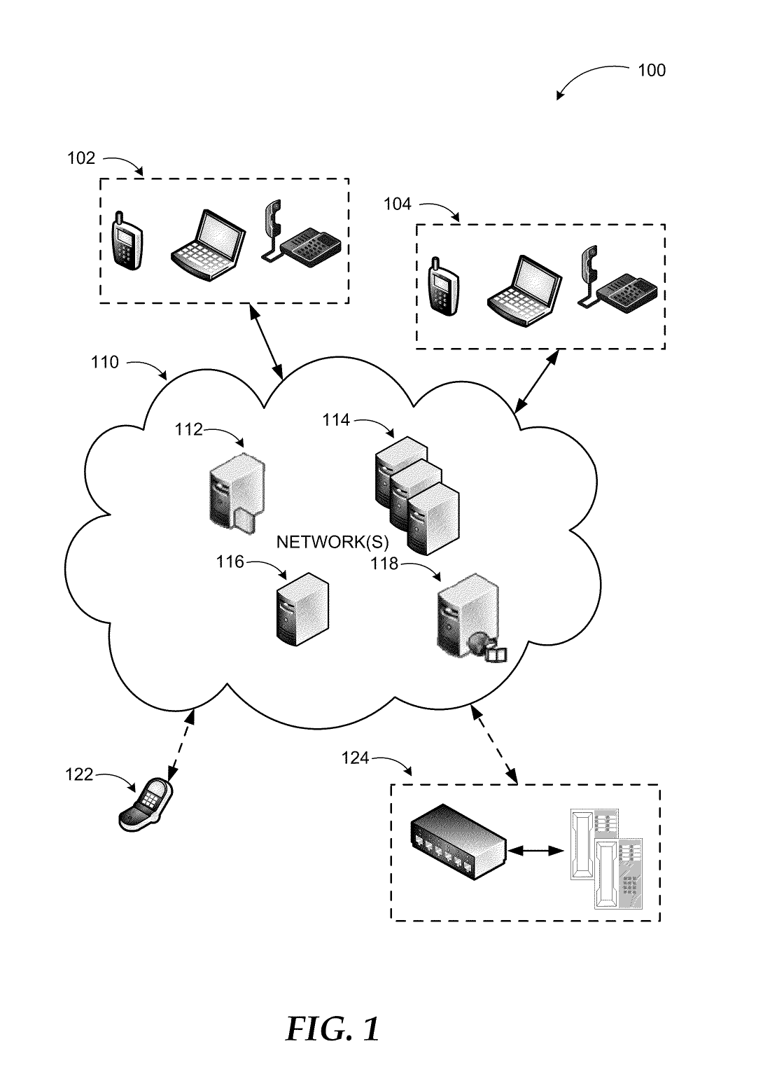

FIG. 1 illustrates diagram 100 of an example unified communications system, where embodiments may be implemented for managing multimodal conversations through centralized notification. A unified communication system is an example of modern communication systems with a wide range of capabilities and services that can be provided to subscribers. A unified communication system is a real-time communications system facilitating instant messaging, presence, audio-video conferencing, web conferencing, and similar functionalities.

In a unified communication (“UC”) system such as the one shown in diagram 100, users may communicate via a variety of end devices (102, 104), which are client devices of the UC system. Each client device may be capable of executing one or more communication applications for voice communication, video communication, instant messaging, application sharing, data sharing, and the like. In addition to their advanced functionality, the end devices may also facilitate traditional phone calls through an external connection such as through PBX 124 to a Public Switched Telephone Network (“PSTN”). End devices may include any type of smart phone, cellular phone, any computing device executing a communication application, a smart automobile console, and advanced phone devices with additional functionality.

UC Network(s) 110 includes a number of servers performing different tasks. For example, UC servers 114 provide registration, presence, and routing functionalities. Routing functionality enables the system to route calls to a user to anyone of the client devices assigned to the user based on default and/or user set policies. For example, if the user is not available through a regular phone, the call may be forwarded to the user's cellular phone, and if that is not answering a number of voicemail options may be utilized. Since the end devices can handle additional communication modes, UC servers 114 may provide access to these additional communication modes (e.g. instant messaging, video communication, etc.) through access server 112. Access server 112 resides in a perimeter network and enables connectivity through UC network(s) 110 with other users in one of the additional communication modes. UC servers 114 may include servers that perform combinations of the above described functionalities or specialized servers that only provide a particular functionality. For example, home servers providing presence functionality, routing servers providing routing functionality, and so on. Similarly, access server 112 may provide multiple functionalities such as firewall protection and connectivity, or only specific functionalities.

Audio/Video (A/V) conferencing server 118 provides audio and/or video conferencing capabilities by facilitating those over an internal or external network. Mediation server 116 mediates signaling and media to and from other types of networks such as a PSTN or a cellular network (e.g. calls through PBX 124 or from cellular phone 122). Mediation server 116 may also act as a Session Initiation Protocol (SIP) user agent.

In a UC system, users may have one or more identities and endpoints, which is not necessarily limited to a phone number. The identity may take any form depending on the integrated networks, such as a telephone number, a Session Initiation Protocol (SIP) Uniform Resource Identifier (URI), or any other identifier. While any protocol may be used in a UC system, SIP is a commonly used method.

SIP is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer.

SIP clients may use Transport Control Protocol (“TCP”) to connect to SIP servers and other SIP endpoints. SIP is primarily used in setting up and tearing down voice or video calls. However, it can be used in any application where session initiation is a requirement. These include event subscription and notification, terminal mobility, and so on. Voice and/or video communications are typically done over separate session protocols, typically Real Time Protocol (“RTP”).

A UC system may provide a platform for social networking, multimodal enterprise communications, and similar environments. Subscriber of such systems may participate in multimodal conversations managed by enhanced communication application(s). In a system according to embodiments, participants may initiate a conversation through selected endpoint. Each participant may have a number of endpoints available to them with varying communication and other capabilities. For example, a desktop communication application may be able to facilitate audio, video, text based communications and a number of application sharing sessions (e.g. whiteboard sharing, desktop sharing, and the like). Later in the conversation, one of the participants may switch to another endpoint with different capabilities (e.g. a handheld device that is capable of audio and text based communication only). The endpoints of the participants may publish their existence and their capabilities to a centralized server enabling the server to make all endpoints aware of others' capabilities. When the participant switches endpoints, the conversation may be continued through a pull mechanism used by the new endpoint such that the change is seamless to the participants (i.e. they do not end the first session and start a new one). More detailed examples are discussed below.

While the example system in FIG. 1 has been described with specific components such as mediation server, A/V server, and similar devices, embodiments are not limited to these components or system configurations and can be implemented with other system configuration employing fewer or additional components. Functionality of systems managing multimodal conversations through centralized notification may also be distributed among the components of the systems differently depending on component capabilities and system configurations. Furthermore, embodiments are not limited to unified communication systems. The approaches discussed here may be applied to any data exchange in a networked communication environment using the principles described herein.

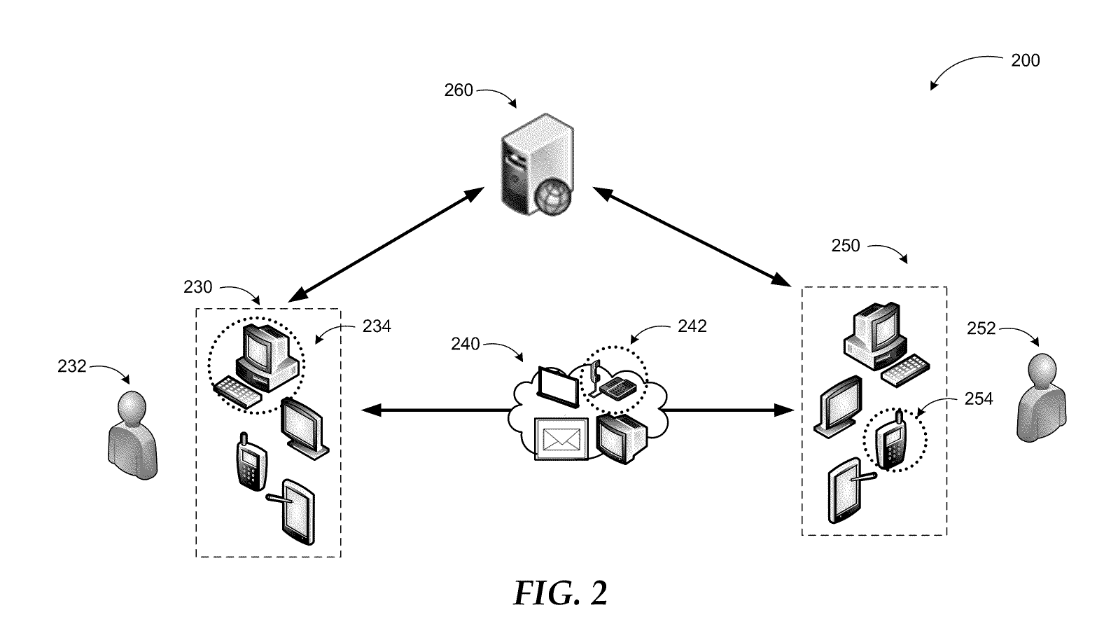

FIG. 2 is a diagram illustrating an example conversation between subscribers of an enhanced communication system with access to multiple endpoints. While a system according to embodiments is likely to include a number of servers, client devices, and services such as those illustratively discussed in FIG. 1, only those relevant to embodiments are shown in FIG. 2.

In an enhanced communication system such as a unified communication system, subscribers (e.g. 232, 252) may facilitate multimodal communications 240 employing one or more end devices (e.g. 230, 250) and associated peripherals. Multimodal communication 240 may include audio, video, file sharing, desktop sharing, instant messaging, electronic mail, whiteboard sharing, and similar forms of communication. The conversation may be established and managed by one or more servers in a distributed fashion (e.g. server 260).

In a conventional communication system, a conversation may be started on one endpoint and live on this endpoint. It is challenging to transfer this conversation (especially in non-audio modes) or to add another modality (e.g. audio modality 242) to the conversation from another endpoint. A system according to embodiments enables subscribers of an enhanced communication system to retrieve a conversation on another endpoint using a pull mechanism. To accomplish this task, each endpoint may publish its state and conversations in real time on a centralized server such as presence server 260. Other endpoints being aware of the status of the currently used endpoint (254) by the subscriber 252 in multimodal conversation 240, subscriber 252 may use any of the other endpoints 250 associated with him/her and initiate a pull to continue the conversation from the new endpoint. This creates a seamless experience for the user with the ability to retrieve conversations active on another endpoint.

Multimodal conversation 240 may be managed by one or more servers. According to one example implementation, server 260 may manage all aspects of the conversation. Alternatively, a distributed system of servers may manage the communication system, where each server is responsible for a particular aspect of the provided services. For example, server 260 may be a presence server receiving published presence information from clients of the system and making those available to other clients.

According to one embodiment, the state of the endpoints may be shared within the system through presence channel. Thus, each endpoint (e.g. endpoint 234 associated with user 232) may publish their presence state and active conversation list (in which they participate) to server 260, which may aggregate the conversation lists from all endpoints and publish the aggregated lists to all endpoints such that an endpoint can initiate a pull mechanism based on an invite message transmitted with replace message to replace a currently used endpoint in an ongoing conversation. Thus, the subscribers are made aware of the details of ongoing conversations through their various endpoints (e.g. type, length, contacts, priorities. and the like) and are enabled to select a conversation and an endpoint to continue the selected conversation. The endpoints may receive the information from server 360 through subscribing to self-presence updates.

Participants in a multimodal conversation such as the one shown in diagram 200 may be part of the same network (e.g. an enterprise network), connected through different networks (e.g. in a federated environment), or communicate via a combination of secure and unsecure networks such as the Internet. Appropriate security measures such as personal identification numbers, passwords, and comparable ones may be employed to ensure privacy and security of the conversation.

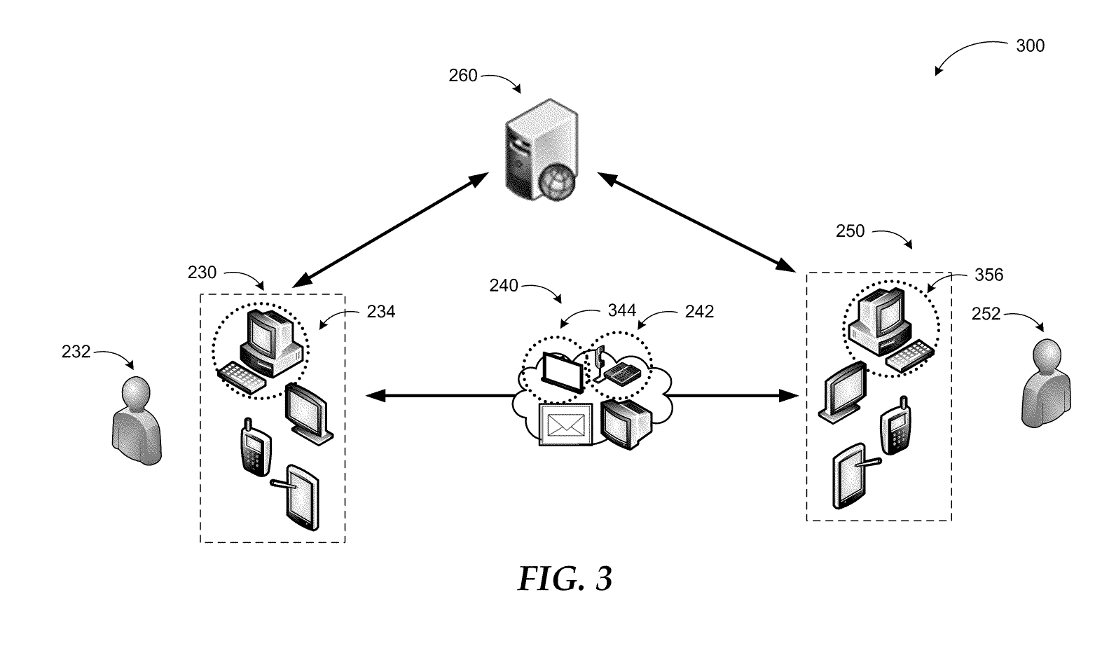

FIG. 3 is a diagram illustrating the example conversation of FIG. 2, where one of the subscribers changes their endpoint continuing the conversation. According to the example scenario illustrated in diagram 300, the original conversation may include audio mode only. Upon switching to endpoint 356 from his/her original endpoint 254, subscriber 252 may add new modality 344 (whiteboard sharing) to the ongoing conversation.

To accomplish the switch, endpoint 356 may initiate a pull by sending a SIP invite with replace. Since all endpoints are aware of each other's states and the ongoing conversation(s), the transition may be achieved seamlessly enabling various conversation parameters to be preserved (e.g. generated documents, records, participants, security attributes, and comparable ones). Thus, when the conversation ends, conversation records (history) may be archived through reconciliation.

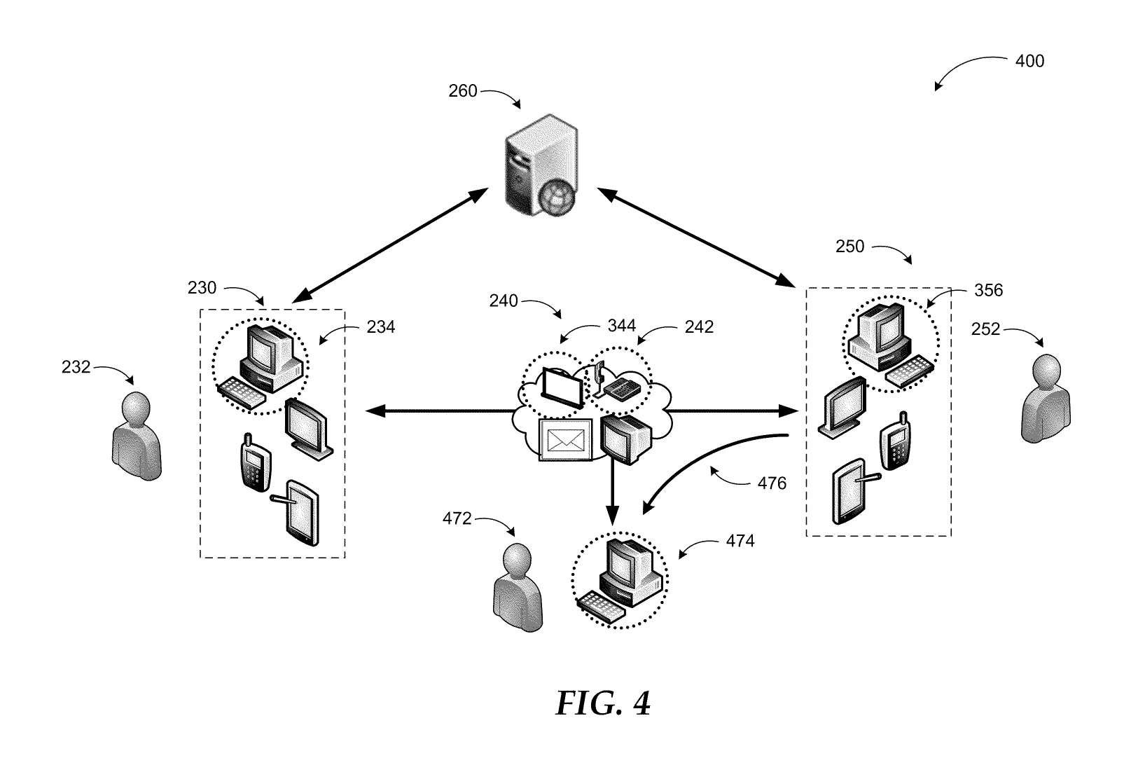

FIG. 4 includes diagram 400 illustrating the example conversation of FIG. 3, where one of the subscribers invites a new participant to the conversation and the modalities of the conversation changes. Upon switching to new endpoint 356 and adding new modality 344 to the conversation, subscriber 252 may invite (476) subscriber 472 with his/her endpoint 474 to conversation 240. The seamless transition to the new endpoint with additional capabilities enables subscriber 252 to invite subscriber 472 with the same capabilities.

As with existing endpoints 230 and 250, the newly added endpoint 474 may also publish its state and conversation list to server 260 such that subscriber 472 can subsequently switch endpoints similar to the process described in conjunction with FIGS. 2 and 3.

The example systems in FIGS. 1 through 4 have been described with specific components such as communication servers, directory servers, presence servers, and the like, embodiments are not limited to communication systems according to these example configurations. A multimodal communication system employing conversation state and transfer through centralized notification may be implemented in configurations employing fewer or additional components and performing other tasks.

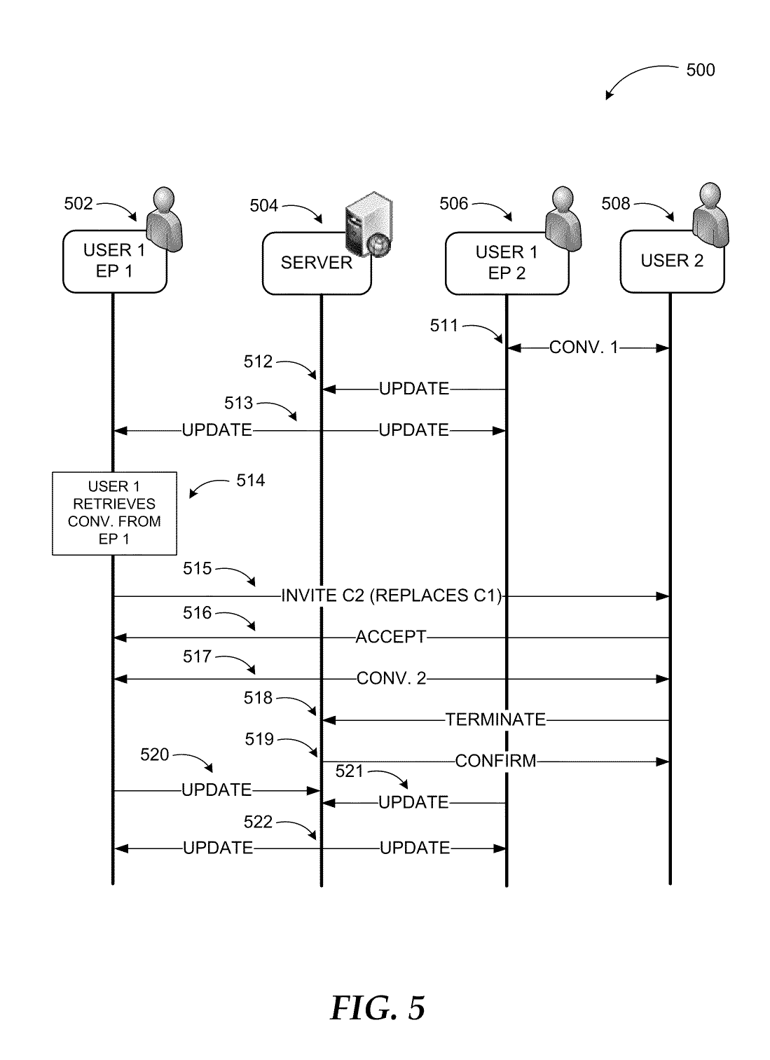

FIG. 5 is an action diagram illustrating interactions between the components of an enhanced communication system according to embodiments. Action diagram 500 illustrates interactions between two different endpoints of one user, another user, and a server managing the endpoint transitions in a conversation. It should be noted that embodiments are not limited to these exemplary components and may be implemented in any configuration of endpoints, users, and servers.

According to the example scenario in diagram 500, user 1 (506) and user 2 (508) are in a conversation (CONV. 1) 511. User 1 participates in the conversation through his/her endpoint 2. Endpoint 2 provides update (512) on its status and the ongoing conversation to server 504 (e.g. through presence publication). Upon receiving this update, server 504 updates (513) all endpoints such that they are aware of the ongoing conversation and its parameters.

At some point during the conversation, user 1 switches to endpoint 1 from endpoint 2 (514). This is done by endpoint 1 (502) sending an invite message 515 with replace to user 2's endpoint (508). The message indicates to user 2's endpoint that conversation 2 will replace conversation 1 with the same parameters as a continuation. Upon acceptance (516) by user 2's endpoint, conversation 2 (517), which is a continuation of conversation 1 is facilitated between endpoint 1 of user 1 and the endpoint of user 2.

When user 2 wishes to end the conversation, the endpoint of user 2 sends a terminate message (518) to server 504. Server 504 confirms (519) the termination to the endpoint of user 2. This is followed by updates (520, 521) from the endpoints to server 504. In return, server 504 updates (522) the endpoints with the latest status. Conversation records may be maintained for the entire conversation (1 and 2).

The above discussed scenarios, example systems, interactions, or applications are for illustration purposes. Embodiments are not restricted to those examples. Other forms of interactions, configurations, and applications may be used in implementing management of conversations through centralized notification in a similar manner using the principles described herein.

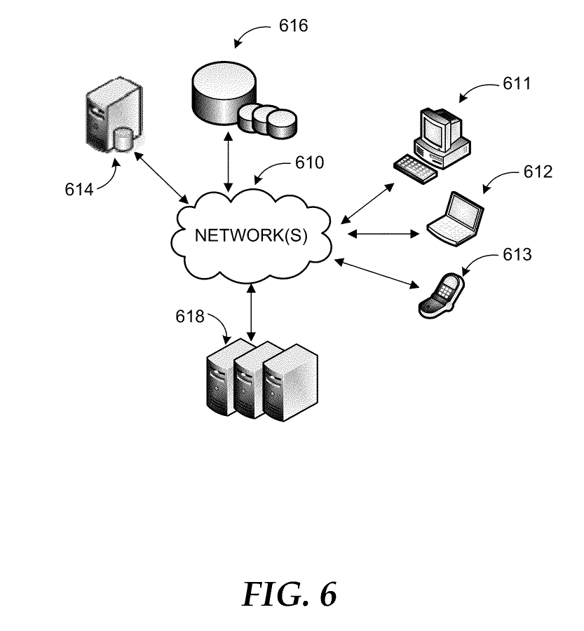

FIG. 6 is an example networked environment, where embodiments may be implemented. A platform providing multimodal conversation state and transfer through centralized notification in enhanced communication systems may be implemented via software executed over one or more servers 618 such as a hosted service. The platform may communicate with client applications on individual computing devices such as a smart phone 613, a laptop computer 612, and desktop computer 611 (‘client devices’) through network(s) 610.

As discussed above, endpoints (e.g. client devices 611-613) may publish their presence to the managing application or a module thereof, which may then enable an endpoint activated by a participant to pull an ongoing conversation and allow the conversation to continue seamlessly with the new endpoint replacing the participant's previous endpoint. A communication service or application executed on servers 618 may receive input from users through client devices 611, 612 or 613, enable transfer of the conversation to a new endpoint configuration, invitation of new participants, modification of modalities, and comparable actions. Data associated with the conversation, participants, and endpoints may be stored to and retrieved from data stores 616, which may be directly accessible or managed by a data management server 614.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to implement a communication system with multimodal conversation state and transfer through centralized notification. Furthermore, the networked environments discussed in FIG. 6 are for illustration purposes only. Embodiments are not limited to the example applications, modules, or processes.

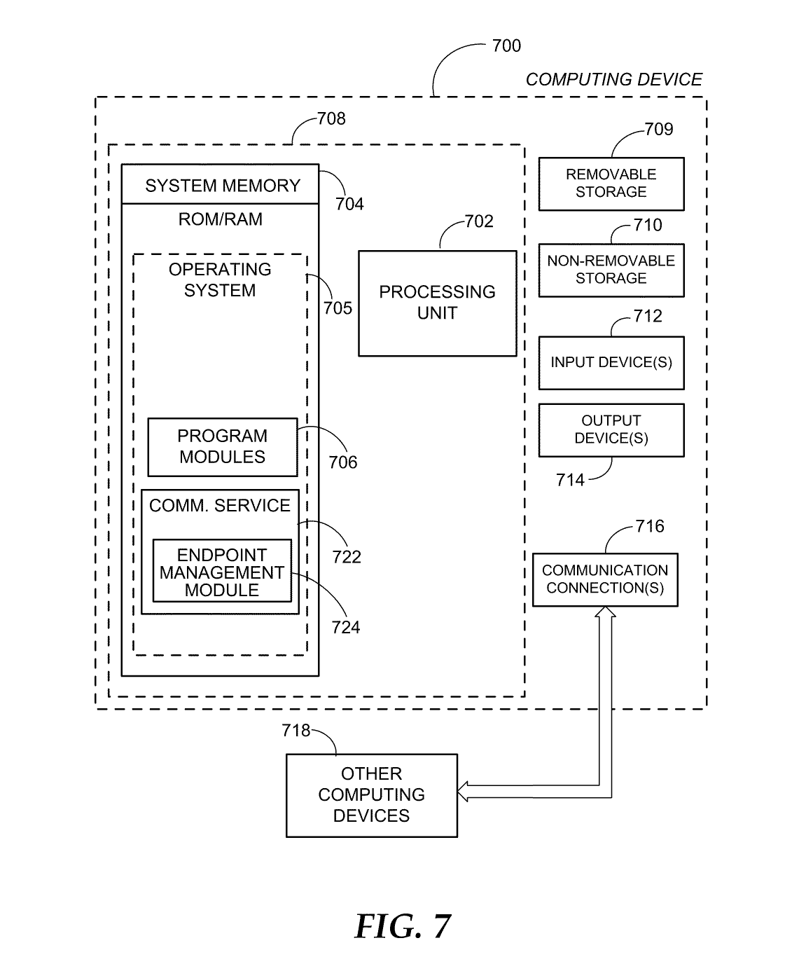

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may be a server managing a communication application or service (e.g. a presence server) and include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS® operating systems from MICROSOFT CORPORATION of Redmond, Wash. The system memory 704 may also include one or more software applications such as program modules 706, communication service 722, and endpoint management module 724.

Communication service 722 may be any application that facilitates communication between client applications and servers relevant to an enhanced communication system. Alternatively, communication service 722 may operate one specific aspect of enhanced communications such as presence. Endpoint management module 724 may receive published endpoint information, enable activation and replacement of endpoints associated with a participant of a conversation while the conversation is continuing providing a seamless transition to the new endpoint configuration without losing conversation related data as discussed previously. Endpoint management module 724 and communication service 722 may be separate applications or integral modules of a hosted service that provides enhanced communication services to client applications/devices. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wired or wireless network in a distributed computing environment, a satellite link, a cellular link, a short range network, and comparable mechanisms. Other devices 718 may include computer device(s) that execute communication applications, other directory or policy servers, endpoints, and comparable devices. Communication connection(s) 716 is one example of communication media. Communication media can include therein computer readable instructions, data structures, program modules, or other data. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

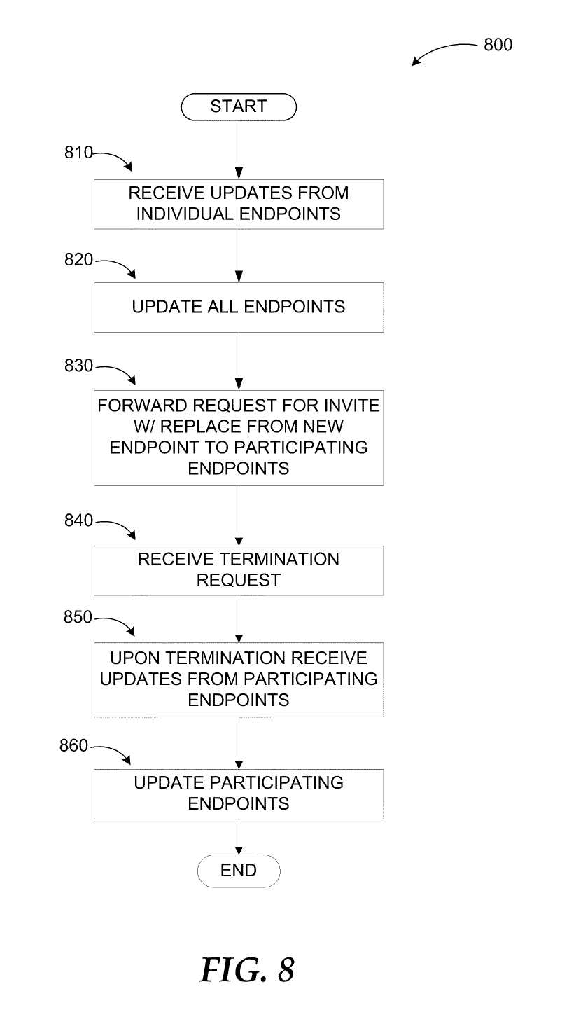

FIG. 8 illustrates a logic flow diagram for process 800 of managing multimodal conversations through centralized notification according to embodiments. Process 800 may be implemented at a management server as part of an enhanced communication system.

Process 800 begins with operation 810, where updates are received from endpoints participating in one or more conversations about their states and the conversation(s) they participate in. At operation 820, all endpoints are updated such that they are aware of the ongoing conversations. When a user attempts to retrieve an ongoing conversation their new endpoint sends an invite with a replace message. The invite may be forwarded to other endpoints participating in the ongoing conversation at operation 830. Upon acceptance of the invite, the conversation may be continued through the new endpoint for the switching user. According to some embodiments, a plurality of conversations may be occurring prior to the establishment of the new conversation and the new conversation may be the continuation of one or more of the plurality of conversations. As discussed previously, new modalities or participants may be added in the continuing conversation.

At operation 840, a termination request is received from one of the endpoints. Upon confirmation of the termination request, updates may be received from participating endpoints regarding their states and the terminated conversation at operation 850. A final update may be provided to all participating endpoints at operation 860 and conversation records maintained as configured. The updates from the endpoints may include information associated with a state of each endpoint, a capability of each endpoint, and/or information associated with the conversation. The information associated with the conversation may include a type, a length, a modality(ies), a duration, or a priority of the conversation, and a list of participants.

The operations included in process 800 are for illustration purposes. Management of multimodal conversations in enhanced communication systems through centralized notification may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for managing multimodal conversation state and transfer through centralized notification in an enhanced communication system, the method comprising:
receiving updates from endpoints participating in a first conversation;
publishing the updates to all endpoints associated with participants of the first conversation;
enabling establishment of a second conversation by one of the endpoints associated with participants of the first conversation, wherein the second conversation is a continuation of the first conversation;
receiving updates from endpoints participating in the second conversation; and
publishing the updates to all endpoints associated with participants of the second conversation.

2. The method of claim 1, wherein the second conversation is established through transmission of an invite message with a replace parameter from an endpoint selected by one of the participants.

3. The method of claim 2, wherein the replace parameter indicates to receiving endpoints which conversation is being continued by the second conversation.

4. The method of claim 1, wherein the updates from the endpoints participating in the first conversation include information associated with at least one from a set of: a state of each endpoint, a capability of each endpoint, and information associated with the first conversation.

5. The method of claim 4, wherein the information associated with the first conversation includes at least one from a set of: a type of the conversation, a length of the conversation, a list of participants of the conversation, and a priority of the conversation.

6. The method of claim 4, wherein the updates from the endpoints participating in the first conversation are received through a presence publication and updates are published to all endpoints associated with the participants of the first conversation through subscription to a self-presence channel.

7. The method of claim 1, further comprising:
enabling the endpoints to add a new modality to one of the first and the second conversations.

8. The method of claim 7, wherein the endpoint adding the new modality is enabled to add the new modality based on at least one of: a capability of other participating endpoints and a preference of subscribers associated with the other participating endpoints.

9. The method of claim 1, further comprising:
enabling the endpoints to invite a new participant to one of the first and second conversations.

10. The method of claim 1, further comprising:
archiving combined records of the first and second conversations by reconciling the records upon termination of the second conversation.

11. The method of claim 1, wherein the modalities of the first and second conversations include one from a set of: audio communication, video communication, an application sharing session, a data sharing session, a whiteboard sharing session, an electronic mail exchange, and an instant message session.

12. A communication system for managing multimodal conversation state and transfer through centralized notification in an enhanced communication system, the system comprising:
a communication server configured to facilitate multimodal communications between endpoints of the system;
a presence server configured to:
receive presence updates from endpoints participating in a first conversation;
publish the updates to endpoints associated with participants of the first conversation through a self-subscription presence channel such that the endpoints are enabled to establish a second conversation, the second conversation being a continuation of the first conversation;
receive presence updates from endpoints participating in the second conversation; and
publish the updates to all endpoints associated with participants of the second conversation through the self-subscription presence channel.

13. The system of claim 12, wherein the parameters include at least one from a set of: modalities of the conversation, documents generated during the conversation, records of the conversation, a list of participants, and security attributes.

14. The system of claim 12, wherein a subscriber associated with one of the endpoints is enabled to at least one of: add a new modality and invite a new participant to one of the first and the second conversations based on the preserved parameters.

15. The system of claim 12, wherein the first and second conversations are facilitated by one of: dedicated servers for each distinct modality of the conversations, multipurpose servers, and a combination of servers and endpoints.

16. The system of claim 12, wherein the enhanced communication system is implemented as one of: a single network system in an enterprise environment and a multi-network system in a federated environment.

17. A computer-readable storage medium with instructions stored thereon for managing multimodal conversation state and transfer through centralized notification in an enhanced communication system, the instructions comprising:
receiving updates from endpoints participating in a plurality of conversations, wherein the updates include a state of each endpoint and a list of conversations associated with each endpoint;
aggregating the updates;
publishing the aggregated updates to all endpoints associated with participants of the plurality of conversations;
receiving an invite message with a replace parameter from one of the endpoints for initiating a new conversation, wherein the new conversation is a continuation of a selected one of the plurality of conversations;
enabling the endpoint initiating the new conversation to add a modality to the new conversation based on capabilities of the endpoint; and
upon termination of the new conversation, archiving combined records of the new conversation and the conversation replaced by the new conversation by reconciling the records.

18. The computer-readable medium of claim 17, wherein the instructions further comprise:
providing a subscriber associated with the endpoint initiating the new conversation information about at least one conversation facilitated by the subscriber's other endpoints.

19. The computer-readable medium of claim 18, wherein the information provided to the subscriber includes at least one from a set of: modalities of the at least one conversation, a duration of the at least one conversation, participants of the at least one conversation, and a priority status of the at least one conversation.

20. The computer-readable medium of claim 17, wherein the instructions further comprise:
enabling the endpoint initiating the new conversation to replace at least two of the plurality of conversations with the new conversation.
